(19) United States
(12) Patent Application Publication
(10) Pub. No.: US 2006/0105290 A1
(43) Pub. Date: May 18, 2006

(54) Holder for holding a dental model for the production of rotational images and mounting device therefor

(76) Inventors: Wolfgang Eiff, Heppenheim (DE); Nadjaf Mougoui, Gross-Gerau (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/267,324

(22) Filed: Nov. 7, 2005

(30) Foreign Application Priority Data
Nov. 12, 2004 (DE) 10 2004 054 880.3

(51) Int. Cl. A61C 1/14

(52) U.S. Cl. 433/49

(57) ABSTRACT

A holder (1) for a tooth model (2) for the purpose of scanning the tooth model (2), includes a work holding component (3) to accommodate the tooth model (2) and a shaft (4) connected to the work holding component (3) for attachment thereof to a mount (8, 15) of a scanning system, the shaft including a coupling component which comprises a cone (6). A mounting device for the holder (1) includes a mandrel (8, 15) is in the form of a counter cone (10, 17).

The invention relates to a holder for a tooth model for scanning the tooth model, comprising a work holding component to accommodate the model and a shaft connected to the work holding component for attachment thereof to a mount of a scanning device, which shaft shaft exhibits a coupling component comprising a cone. The invention also relates to a mounting device for a holder of the type mentioned above, which mounting device exhibits a mandrel in the form of a counter cone adapted to accommodate the holder.

### DESCRIPTION OF THE RELATED ART

The prior art includes holders for tooth models for use when tooth models are to be scanned. Depending on the scanning method employed as well as on the size of the tooth model to be scanned, there are holders that are designed for holding a single tooth model and others that can hold an entire mandibular cast.

It is often desirable to scan a single tooth model from several directions at the same time. To this end, the prior art discloses holders which are rotatable relatively to the image detecting unit. The company etkon AG distributes scanning devices, which have holders that are securely mounted on the equipment and can be rotated relatively to the image detecting unit. The holders contain a plastic modeling material, to which the tooth models to be scanned are fixed. The rigid attachment of the holders in the device is a disadvantage with this approach. Also, Sirona Dental System GmbH sells pot holders that can be fastened by means of a screwed mounting device so that they can be rotated on a mounting device. The assembly and disassembly of such a holder requires increased effort.

Patent application DE 195 47 137 A1 discloses a device for holding tooth and/or jaw model parts, in which a model supporting plate is fastened to a baseplate. This attachment is effected, on the one hand, by means of a counterpart of ferromagnetic material and, on the other hand, by concentric shaped guide means between the baseplate and the model supporting plate.

Patent application DE 34 11 363 A1 discloses a dentition model for the fabrication of dental prosthetic items. The tooth stumps of modeling material can be attached to a base by means of pins that are aligned at right angles to the axis of the tooth.

Patent application DE 100 49 186 A1 discloses a dental model base plate made of gypsum having a U-shaped groove for the insertion of tooth models.

It is thus an object of the invention to provide a holder for a tooth model that enables simple, secure, and precise attachment and positioning of the holder in the scanning device, and that is dirt proof and lowers production costs.

### SUMMARY AND OBJECTS OF THE INVENTION

According to the invention, this object is achieved by a holder as defined in claim 1 and also by a mounting device as defined in claim 10.

The holder of the invention for holding a tooth model for scanning the tooth model contains a work holding component to accommodate the tooth model and a shaft connected to the work holding component for attachment to a mount on a scanning device, which shaft exhibits a coupling component comprising a cone. The holder comprising the cone can be fitted over an appropriately designed mount of a scanning device such that the holder is fixed both axially and radially in the required direction on account of the geometry of the cone such that a very good friction lock exists between the mount and the holder. This ensures that the tooth model to be scanned will maintain a radially fixed position during rotation.

Advantageously, the cone is in the form of an inner cone that is disposed on that end of the shaft that is remote from the work holding component. One advantage of the design of the cone as an inner cone is that the counterpart can be designed as an outer cone, while another advantage is that no dirt can collect on the tapered counterpart pointing upwardly.

Advantageously, the work holding component, the shaft, and the coupling component are axially symmetrical. In this way there is no preferential direction involved when mounting the tooth model on the holder, and the holder can be mounted in arbitrary orientation in the mounting device of the scanning device.

Advantageously, the cone has an angle of taper between two and nine degrees. An angle of taper which is too large results in a poor frictional connection and one that is too small impairs centering.

Advantageously, there is a centering section in the inner cone. Such a centering section can, for example, be formed by a cylindrical cavity adjoining the conical region. This ensures even better centering of the holder on the mount.

Advantageously, the shaft is resilient in the region of the cone. This makes it possible to improve the frictional connection between the holder and the mount.

Such elasticity can be achieved by a slit provided in the shaft in the region of the cone.

Advantageously, the work holding component for the tooth model is in the form of a small pot. Such a holder allows for a large number of different mounting options.

Advantageously, this small pot contains a reshapeable compound to which the tooth model can be fixed. This makes it possible to releasably attach a tooth model to be scanned while it is held in the holder sufficiently securely for scanning purposes and at the same time provides the option of manual correction of its position.

A further object of the invention is a mounting device for a holder, as has been revealed above. The mounting device exhibits a mandrel over which the holder can be fitted, which mandrel is designed as a counter cone to the cone of the holder, in particular as an outer cone. Such a mounting device enables very simple, secure, and accurate attachment of the holder thereto.

Advantageously, the mandrel is spring-mounted, the spring travel of the mandrel being limited by a stop. When mounting the holder onto the mandrel the mandrel gives way to an extent depending on the force used to mount the holder and hits the stopper when the intended mounting force has been reached. Subsequent mounting is always effected with the same constant force, so that the holder is always mounted in the same position.

Advantageously, the angle of taper of the mandrel is equal to the angle of taper of the holder within a tolerance of one degree or less. This ensures a secure fit of the holder on the mandrel and provides maximal friction surface.

Advantageously, the mandrel is equipped with a centering pin, which adjoins the cone. This makes it possible to achieve even more accurate positioning of the holder.

### BRIEF DESCRIPTION OF THE DRAWINGS

The holder of the invention is explained below with reference to the drawings, in which:

FIG. 1A shows a longitudinal section of a holder of the invention,

FIG. 1B is a top view of the holder,

FIG. 2 is a perspective view of an alternative embodiment of a holder,

FIG. 3 shows the mounting device of the invention with holder,

FIG. 4 shows the mounting device with a modified design of the mandrel, and

FIG. 5 shows the mounting device with an inserted holder.

### DETAILED DESCRIPTION OF EXEMPLARY EMBODIMENTS OF THE INVENTION

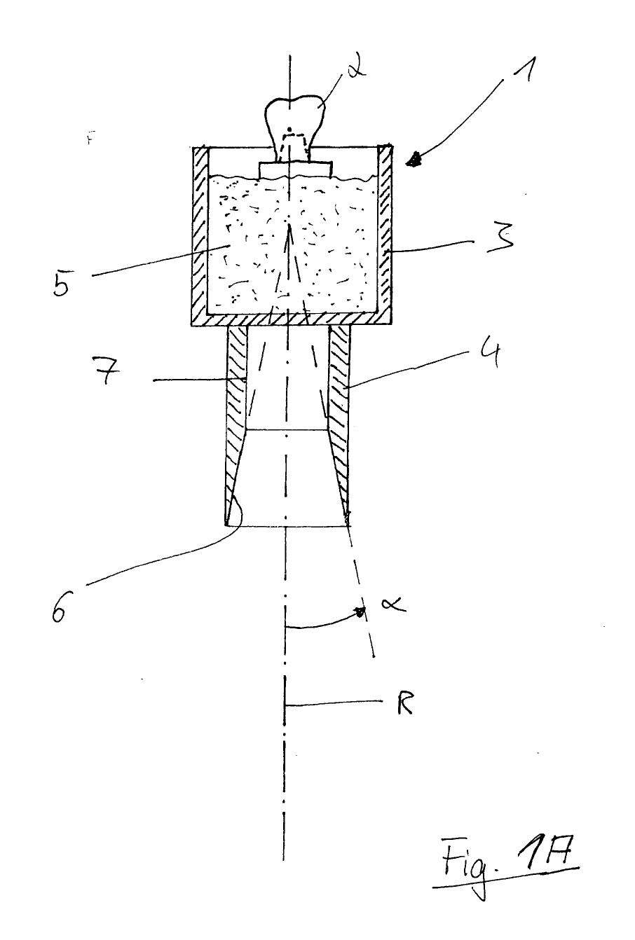

FIG. 1A shows a holder 1 for a tooth model 2, which exhibits a cylindrical, pot shaped part 3 with a shaft 4 attached thereto. The tooth model 2 can alternatively be a prepared stump (shown in dashed lines). The shaft is made of a resilient material which is able to give way slightly when subjected to extending forces. The small pot 3 is filled with a plastic compound 5, for example plastic modeling material, for mounting and positioning the dental model 2. An inner cone 6 which, for the sake of clarity, exhibits an aperture angle a of 12 degrees, is provided at that end of shaft 4 that is remote from the pot. Above the conically formed end of the shaft there is provided a centering section 7, shaped as a hollow portion of the shaft, to accommodate a mandrel and to improve the resilience of the shaft 4. The pot 3, the shaft 4, the cone 6, and the centering section 7 are axially symmetrical relative to the axis of rotation R.

FIG. 1B is a top view of holder 1. The small pot 3 is in the form of a small cylinder whose axis coincides with the axis of rotation R. The tooth model 2 to be scanned is embedded in the modeling compound 5 such that the physical midpoint of the tooth model 2 lies approximately in the axis of rotation R.

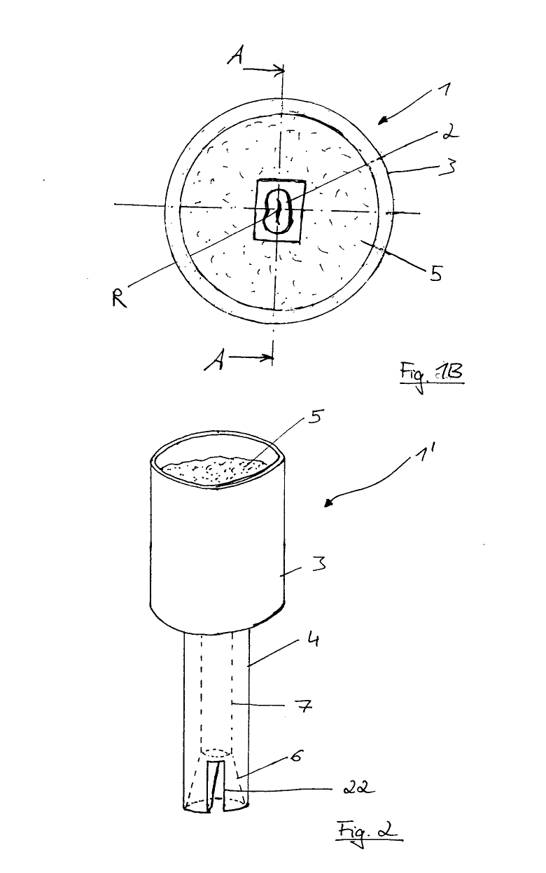

FIG. 2 shows a holder 1′ in an alternative embodiment. The shaft 4 exhibits a slit 22 that spans the region of the cone 6 in order to create resilience.

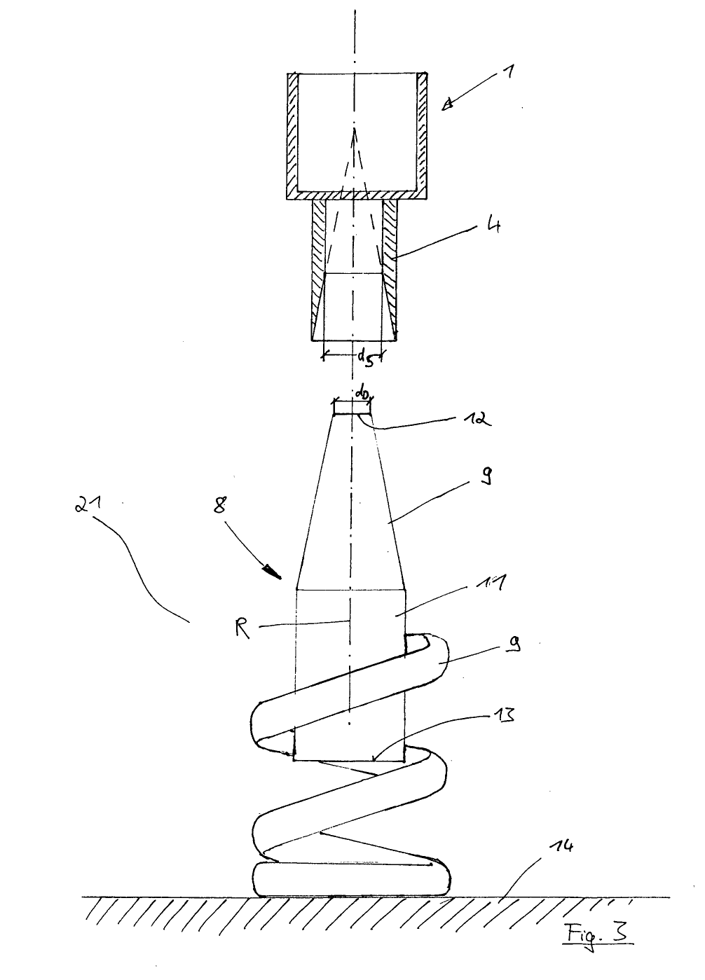

FIG. 3 shows a mounting device 21 of the invention, consisting of a holder 1 and a mandrel 8, which is resiliently mounted by means of a spring 9. The mandrel 8 is divided into a conical part 10 and a cylindrical part 11. The peak 12 of the conical part has a diameter d_{D} and is thus smaller than the diameter d_{S} of the centering section 7 of shaft 4.

When mounting the holder 1 onto the mandrel 8, a force acting in the axial direction is exerted on the mandrel 8, which results in the spring 9 being compressed. The mandrel 8 gives way in accordance with the applied force until its underside 13 hits a stop 14. The force required to push the holder 1 onto the mandrel 8, up to the point of its hitting the stop 14, is always the same. This means that the holder 1 will always be pushed onto the mandrel 8 by a defined force.

The angle of taper is selected such that a friction lock is created between the holder 1 and the mount in the form of a mandrel 8. The adhesive force F_{H} between the conical part of the mandrel (10) and the conical coupling component (6) resulting from the action of the normal force F_{N} is greater than the components of the traction force F′ produced along the cone during the production of rotational images.

Advantageously, the conical coupling component (6) can be of resilient design, in order to increase the normal force F_{N} acting on the surface, and thus to increase the adhesive force F_{H}.

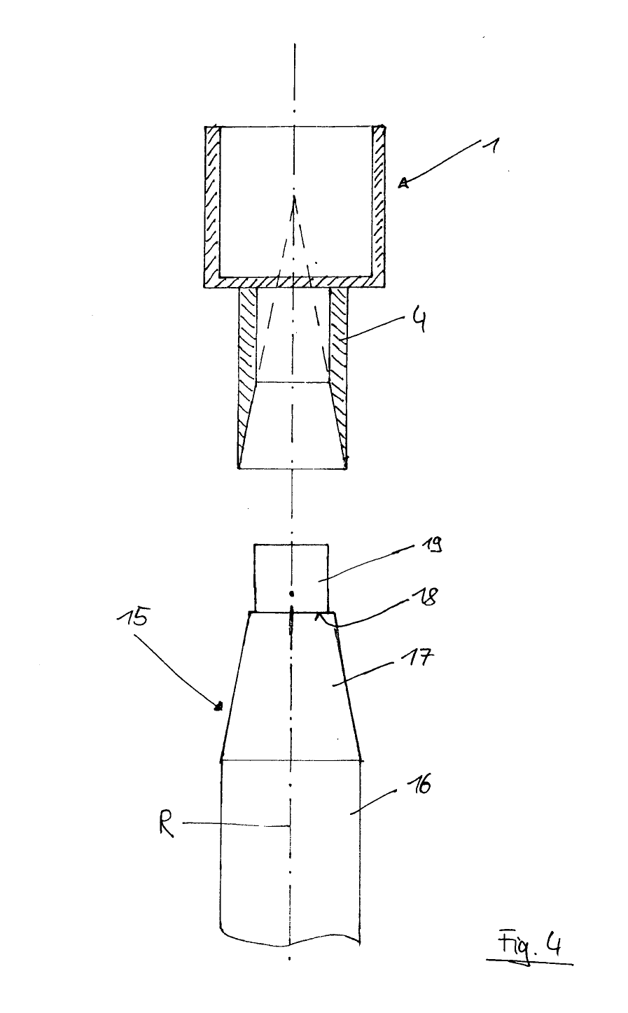

FIG. 4 shows an alternative embodiment of the mandrel 15 of the mounting device 21. The mandrel 15, in this case, exhibits three regions. The cylindrical region 16 is adjoined by a conical region 17, to the front surface 18 of which a centering pin 19 is attached. The centering pin 19 is cylindrical and has substantially the same diameter as the diameter d_{S} of the centering section 7 of the shaft 4. The transition between the conical region 17 and the centering pin 19 is provided with a shoulder, which ensures that when the holder 1 and the mandrel 15 are pushed together, no mispositioning will result due to the fact that the counter surfaces must necessarily bear absolutely flush against each other.

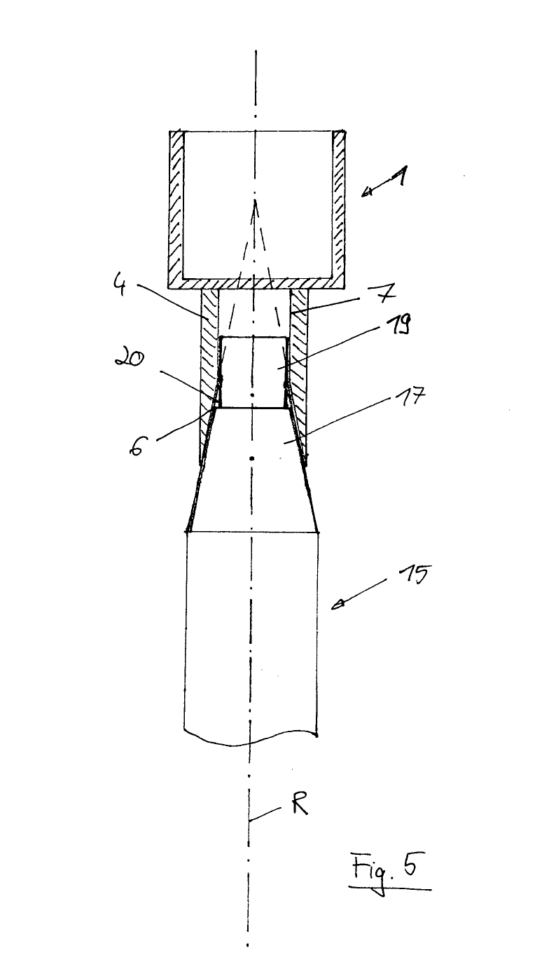

FIG. 5 shows the holder 1 pushed onto the mandrel 15. A cavity 20 is created between the centering pin 19, the conical region 17 and the conical region 6 of the shaft 4, due to the stepped diameters, in which cavity there is no contact between the holder 1 and the mandrel 15.

### LIST OF REFERENCE NUMERALS OR CHARACTERS

1 holder
1′ holder in an alternative embodiment
2 tooth model
3 small pot
4 shaft
6 conical region of the shaft
7 centering section
8 mandrel
9 spring
10 conical region
11 cylindrical region
12 peak of the mandrel
13 underside
14 stop
15 mandrel
16 cylindrical region
17 conical region
19 centering pin
20 cavity
21 mounting device
22 slit
R axis of rotation
d_{D} diameter of the peak of the mandrel
d_{S} diameter of the centering section

1. A holder (1) for a tooth model (2) for the purpose of scanning said tooth model (2), comprising a work holding component (3) for the tooth model (2) and also a shaft (4) connected to said work holding component (3) and adapted for attachment in a mount (8, 15) of a scanning system, wherein said shaft (4) has a coupling component (6) that comprises a cone to create a friction lock between said holder (1) and said mounting device (8, 15), and said work holding component (3), said shaft (4), and said coupling component (6) have substantially the same axis of rotation (R).

2. A holder (1) as defined in claim 1, wherein said cone (6) is an inner cone which is disposed at that end of said shaft (4) which is remote from said work holding component (3).

3. A holder (1) as defined in claim 1, wherein said work holding component (3) for the tooth model (2), said shaft (4), and said coupling component (6) are axially symmetrical.

4. A holder (1) as defined in claim 1, wherein that said cone (6) exhibits an angle of taper of from 1 to 15 degrees.

5. A holder (1) as defined in claim 2, wherein said inner cone (6) is adjoined by a centering section (7).

6. A holder (1) as defined in claim 1, wherein that said shaft (4) is resilient in the region of said cone (6).

7. A holder (1) as defined in claim 1, wherein said shaft (4) is slit in the region of said cone (6).

8. A holder (1) as defined in claim 1, wherein said work holding component (3) for the tooth model (2) is in the form of a small pot (3).

9. A holder (1) as defined in claim 8, wherein in said small pot (3) a reshapeable compound (5) is present in which said tooth model (5) can be fixed.

10. A mounting device (21) for a holder (1) as defined in claim 1, further comprising a mandrel (8, 15) for the attachment of said holder (1), wherein said mandrel (8, 15) is in the form of a counter cone to the cone of said holder (1), in particular an outer cone (10, 17).

11. A mounting device (21) as defined in claim 10, wherein said mandrel (8, 15) is spring-mounted and the spring travel is limited by a stop (14).

12. A mounting device (21) as defined in claim 10, wherein the angle of the cone (10, 17) of said mandrel (8, 15) is equal to the angle of the cone (6) of said holder (1) within a tolerance of 1 degree or less.

13. A mounting device (21) as defined in claim 10, wherein said mandrel (15) has a centering pin (19) which is disposed adjacent to said cone (17).
